(19) United States
(12) Patent Application Publication
(10) Pub. No.: US 2025/0388340 A1
(43) Pub. Date: Dec. 25, 2025

(54) SYSTEM AND METHOD FOR A TIERED SPACECRAFT DOCKING STATION AND LANDER

(71) Applicant: Thomas F. Yost, Chesapeake Beach, MD (US)

(72) Inventor: Thomas F. Yost, Chesapeake Beach, MD (US)

(21) Appl. No.: 19/306,764

(22) Filed: Aug. 21, 2025

Related U.S. Application Data
(63) Continuation-in-part of application No. 18/663,355, filed on May 14, 2024.
(60) Provisional application No. 63/466,327, filed on May 14, 2023.

(51) Int. Cl. B64G 1/10; B64G 1/62; B64G 1/64

(52) U.S. Cl. CPC B64G 1/10; B64G 1/625; B64G 1/6462

(57) ABSTRACT

A tiered spacecraft docking station is adapted to facilitate docking of spacecraft within outer space. A first tier includes a first frame enclosing a first area. A first net-like mesh is coupled to the first frame and fills the first area enclosed by the first frame. A second tier includes a second frame enclosing a second area. A second net-like mesh is coupled to the second frame and fills the second area enclosed by the second frame. A plurality of support beams attach the first frame to the second frame. A lander is used to slow and stop a spacecraft on a celestial body. The lander includes a first and a second webbed structure and a decelerator coupled to the first webbed structure and/or the second webbed structure. The decelerator maintains a tension in the first and/or second webbed structure below a predetermined threshold.

### CROSS REFERENCE TO RELATED APPLICATIONS

The present application claims priority under 35 U.S.C. § 120 as a continuation-in-part application to U.S. application Ser. No. 18/663,355 entitled, “SYSTEM AND METHOD FOR A SPACECRAFT DOCKING STATION,” filed May 14, 2024, which claims priority under 35 U.S.C. § 119 to U.S. Provisional Application No. 63/466,327 entitled, “SPACE CARGO DIRIGIBLE AND LAUNCHER,” filed May 14, 2023, and both of which are hereby expressly incorporated by reference herein.

### FIELD

This application relates to systems and methods for a spacecraft and more specifically, a docking station for cargo containers and other spacecraft in space.

### BACKGROUND

Systems and devices used in space to facilitate space travel, exploration and construction are continuously being researched and developed for various purposes. As spacecraft travel through space, it may be beneficial to provide docking stations for various purposes. Accordingly, improvements and developments of spacecraft docking stations may be desirable.

### SUMMARY

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In one aspect, a tiered spacecraft docking station includes a first frame enclosing a first area and a first net-like mesh coupled to the first frame and filling the first area enclosed by the first frame; a second frame enclosing a second area and a second net-like mesh coupled to the second frame and filling the second area enclosed by the second frame; and a plurality of support seams that attach the first frame to the second frame.

In a second aspect, a lander includes a first webbed structure including first webbing and a second webbed structure including second webbing, wherein the second webbed structure is in parallel with the first webbed structure. A decelerator is coupled to the first webbed structure and/or the second webbed structure.

These and other aspects of the disclosure will become more fully understood upon a review of the detailed description which follows. Other aspects, features, and examples of the present invention will become apparent to those of ordinary skill in the art, upon reviewing the following description of specific, exemplary examples in conjunction with the accompanying figures. While features may be discussed relative to certain examples and figures below, all examples can include one or more of the advantageous features discussed herein. In other words, while one or more examples may be discussed as having certain advantageous features, one or more of such features may also be used in accordance with the various examples of the invention discussed herein. In similar fashion, while exemplary examples may be discussed below as device, system, or method examples it should be understood that such exemplary examples can be implemented in various devices, systems, and methods.

### BRIEF DESCRIPTION OF THE DRAWINGS

FIG. 1 is an isometric view of a spacecraft docking station according to at least one embodiment.

FIG. 2 is a geometric schematic diagram of a docking station according to at least one embodiment.

FIG. 3 is a close-up isometric view of a docking station according to at least one example.

FIG. 4 is a flow diagram depicting an example of a method of making a docking station according to at least one implementation.

FIG. 5 is an isometric view of the docking station configured for refueling and/or adding cargo spheres, assembly, robots, and/or additional main engines to spacecraft according to at least one implementation.

FIG. 6 is another isometric view of the docking station configured for refueling and/or adding cargo spheres, assembly, robots, and/or additional main engines to spacecraft according to at least one implementation.

FIG. 7 is a flow diagram depicting an exemplary method of the docking station for refueling spacecraft according to at least one implementation.

FIG. 8 is an isometric view of an embodiment of a tiered docking station according to at least one implementation.

FIG. 9 is an isometric view of another embodiment of a tiered docking station according to at least one implementation.

FIG. 10 is an isometric view of a cluster of vessels for construction of a docking station according to at least one implementation with robot(s) electromagnetically coupled to the cargo sphere which has an electrically conductive and magnetic outer shell produced from generators inside the sphere.

FIG. 11 is an isometric view of one or more robots for construction of a docking station according to at least one implementation.

FIG. 12 is an isometric view of the robots constructing the docking station according to at least one implementation.

FIG. 13 is an isometric view of constructing the docking station from a plurality of frame portions according to at least one implementation.

FIG. 14A is a flow diagram depicting an embodiment of a method of constructing the docking station according to at least one implementation.

FIG. 14B is a flow diagram depicting an embodiment of a method of constructing a tiered docking station according to at least one implementation.

FIG. 15 is an isometric view of an embodiment of a lander according to at least one implementation.

FIG. 16 is an isometric view of another embodiment of the lander according to at least one implementation.

FIGS. 17A-D are isometric views of a vessel descending and landing on the lander according to at least one implementation.

FIG. 18 is a flow diagram depicting an embodiment of a method of constructing a lander according to at least one implementation.

### DETAILED DESCRIPTION

The word “exemplary” or “embodiment” is used herein to mean “serving as an example, instance, or illustration.” Any implementation or aspect described herein as “exemplary” or as an “embodiment” is not necessarily to be construed as preferred or advantageous over other aspects of the disclosure. Likewise, the term “aspects” does not require that all aspects of the disclosure include the discussed feature, advantage, or mode of operation.

Embodiments will now be described in detail with reference to the accompanying drawings. In the following description, numerous specific details are set forth in order to provide a thorough understanding of the aspects described herein. It will be apparent, however, to one skilled in the art, that these and other aspects may be practiced without some or all of these specific details. In addition, well known steps in a process may be omitted from flow diagrams and descriptions presented herein in order not to obscure the aspects of the disclosure. Similarly, well known components in a device or well-known systems may be omitted from figures and descriptions thereof presented herein in order not to obscure the aspects of the disclosure.

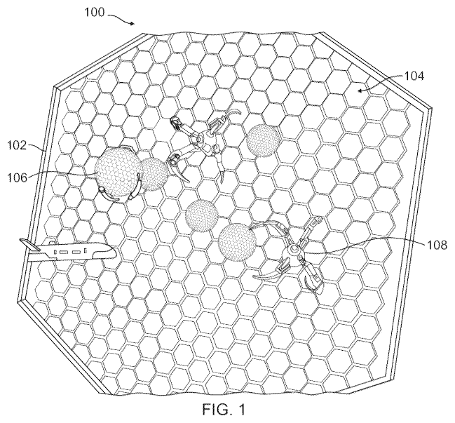

FIG. 1 is an isometric view of a spacecraft docking station 100 according to at least one embodiment. As shown, the spacecraft docking station 100 may include a frame 102 with a net-like mesh 104 coupled to the frame 102 and filling in an area enclosed by the frame 102. The frame 102 may be formed in various shapes. In the embodiment shown, the frame 102 has a hexagonal shape. By way of example and not limitation, the frame may be formed with sides of equal length. For example, each side may be 40 meters. Although a hexagonal shape is shown, it will be apparent to those of ordinary skill in the art that the frame 102 may be other desired shapes, such as circular, square, rectangular, octagonal, triangular, etc.

The net-like mesh 104 may be formed from a plurality of individual wires or wound wires. The individual or wound wires may be formed with an electrically conductive and magnetic material. The net-like mesh 104 may be formed with a geometric pattern with the openings in the mesh being sized and shaped to inhibit the passing of spacecraft through the mesh 104. In the example depicted, the mesh 104 is formed with a hexagonal (e.g., chicken wire) shape. Other shapes may include square, triangular, rectangular, oblong, etc. According to at least one embodiment, the openings in the mesh 104 are sized and shaped to inhibit spherical spacecraft vessels 106 having a diameter of 5 meters from passing through the mesh 104.

In operation, the docking station 100 may receive spacecrafts of various shapes and sizes. As depicted, at least one embodiment of a spacecraft may include ferromagnetic shelled vessels 106, an embodiment of which is described in U.S. patent application Ser. No. 18/664,116, entitled, “SYSTEM AND METHOD FOR DIMPLED SPHERICAL STORAGE UNITS,” by inventor Thomas Yost, and filed on May 14, 2024, the entirety of which is incorporated by reference herein. The magnetic net-like mesh 104 can hold the vessel 106 (or other metallic spacecraft) to the net-like mesh 104 to keep the vessel 106 in place. With a vessel 106 coupled with the net-like mesh 104, maintenance can be performed on the vessel 106, and/or the vessel 106 can provide needed aid to other spacecraft (e.g., fuel, repair parts, provisions, tools, etc.) to facilitate further travel from the docking station 100.

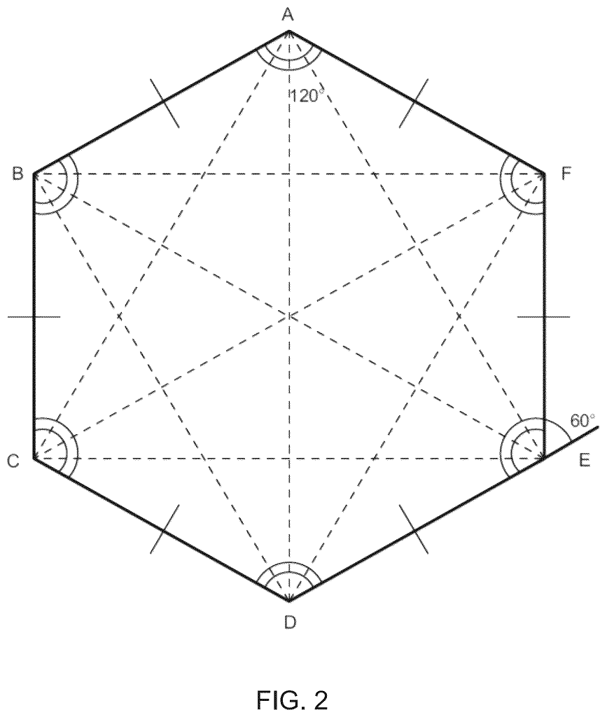

In some embodiments, the docking station 100 may further include a propulsion mechanism to facilitate location and orbit maintenance of the docking station 100. For example, a plurality of vessels 106 may be positioned on the docking station 100, where each vessel 106 provides propulsion using an attachable main engine or thruster. Referring to FIG. 2, a geometric schematic diagram is shown for a docking station 100 formed as a hexagon. In one or more such embodiments, the vessels 106 may be positioned at corners relative to each other to form a rectangle within the hexagon. For example, a respective vessel 106 and/or an attachable main engine 106 may be positioned at each point B, F, C, and E in FIG. 2 to provide thrust and/or maneuvering thrusters to the docking station 100 as needed.

In various implementations, the docking station 100 may be positioned in orbit where desired. In at least one implementation, the docking station 100 may be positioned in orbit at 51.6° to match the International Space Station (ISS), which can facilitate providing supplies and oxygen to the ISS. In at least another implementation, a docking station 100 may be positioned at 0° on the equator in a geosynchronous orbit, to facilitate reception of one or more vessels 106 launched from the upper stratosphere toward the docking station 100.

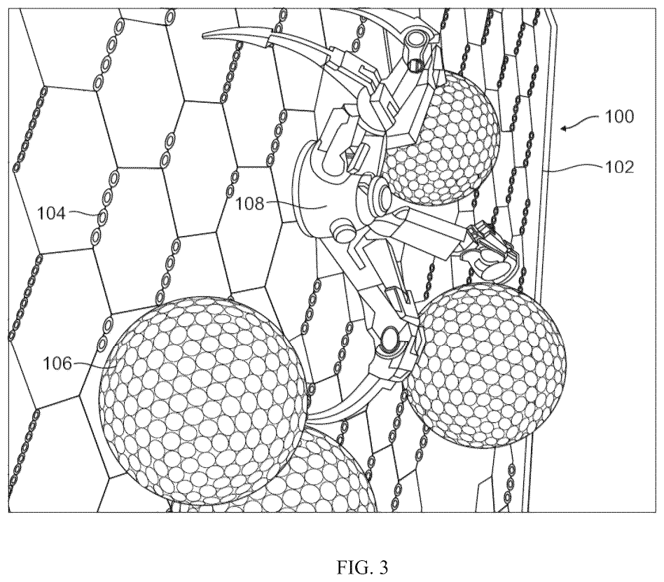

Referring back to FIG. 1, according to various aspects of the disclosure, the docking station 100 may further include at least one robot 108. The robot 108 may be autonomous to help manage spacecraft at the docking station 100. FIG. 3 is a close-up isometric view of the docking station 100 illustrating a robot 108 and several vessels 106 stationed at the docking station 100. As shown, the robot 108 may comprise a spider-shaped body with several legs extending from a central body. With an electrical current running through the net-like mesh 104, an electromagnetic effect can maintain the robot 108 attached to the net-like mesh 104, as well as the vessels 106. As depicted in FIG. 3, the robot 108 can aid the vessels 106 in attaching to the mesh 104. Using several vessels 106, the robot 108 may also arrange the vessels together in a cluster or lattice structure to form a larger spacecraft, an embodiment of which is described in U.S. patent application Ser. No. 18/664,170, entitled, “SYSTEM AND METHOD FOR SMART SPHERICAL CLUSTER VESSELS,” by inventor Thomas Yost, and filed on May 14, 2024, the entirety of which is incorporated by reference herein.

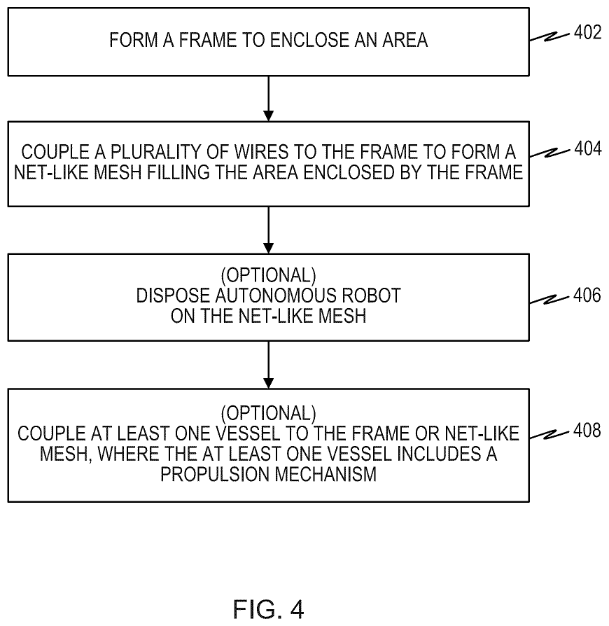

Additional aspects of the present disclosure include methods of making a docking station, such as the docking station 100. FIG. 4 is a flow diagram depicting a method of making a docking station according to at least one implementation. With reference to FIGS. 1-4, a frame 102 may be formed to enclose an area at 402. The frame 102 may be formed in a plurality of various shapes. As discussed herein, the frame 102 may be formed in a geometric shape having all sides with an equal length, according to some embodiments. In various embodiments, the frame 102 may be formed with a shape of a hexagon, circle, square, rectangle, octagon, triangle, etc.

At 404, a plurality of wires may be coupled to the frame 102 to form a net-like mesh 104 filling the area enclosed by the frame 102. As discussed herein above, the plurality of wires may be individual wires and/or wound wires. The individual or wound wires may be formed with an electrically conductive and/or magnetic material. The net-like mesh 104 may be formed with a geometric pattern with the openings in the mesh being sized and shaped to inhibit the passing of spacecraft through the mesh 104. By way of example, and not limitation, the mesh 104 may be formed with a pattern of shapes selected from a hexagon, square, triangle, rectangle, or oblong shape.

According to some implementations, the method may further include an optional step at 406 of disposing an autonomous robot 108 onto the net-like mesh 104. As described herein, the robot 108 may comprise a spider-shaped body with several legs extending from a central body, and may be coupled to the net-like mesh 104 by an electromagnetic effect.

In some implementations, at step 408, one or more vessels 106 may also be coupled to the frame 102 and/or the net-like mesh 104, where the one or more vessels 106 include a propulsion mechanism.

### Embodiment of a Space Station

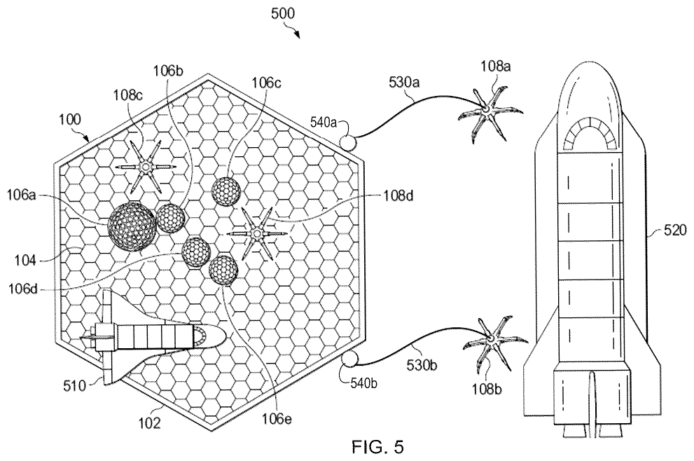

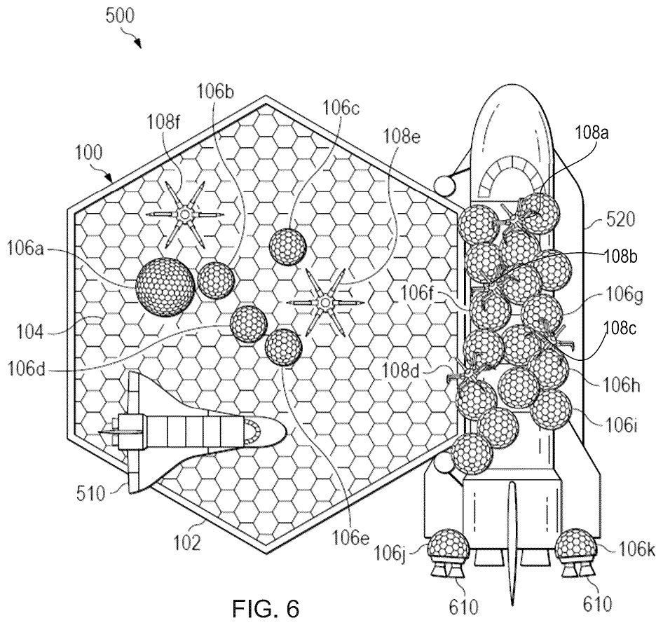

FIGS. 5-6 illustrate isometric views of a spacecraft docking station 100 configured for providing a plurality of services to spacecraft 510, 520. For example, the docking station 100 provides refueling of the spacecraft, loading or unloading vessels 106 or other cargo, assembly of parts, loading or unloading of robots 108, providing additional main engines or other parts or other services. The vessels 106a-e are, in an embodiment, spherical vessels, as described in U.S. patent application Ser. No. 18/664,116, entitled, “SYSTEM AND METHOD FOR DIMPLED SPHERICAL STORAGE UNITS,” by inventor Thomas Yost, and filed on May 14, 2024, the entirety of which is incorporated by reference herein, though other types of vessels or storage units may be implemented on the docking station 100. One or more autonomous robots 108a-d move on the net-like mesh 104 to assist in docking and servicing of the spacecraft.

As shown in FIG. 5, a first spacecraft 510, such as a space shuttle or the Blue Origin® spacecraft, is attached to the net-like mesh 104 within the frame 102, e.g., in this example for refueling. When a spacecraft is too large for attachment within the frame 102, such as spacecraft 520, it may be attached to a side of the frame 102, e.g., using one or more strandlines 530a-b. The spacecraft 520 includes, e.g., the SpaceX® Starship or other types of vessel. One or more autonomous robots 108a-d, in communication with the spacecraft 520, move from the electrically conductive and magnetic mesh 104 onto a designated dead spot (non-electromagnetic). Without the force helping to hold the one or more robots to the mesh 104, at least a first robot 108a leaps from the mesh 104 to the docking spacecraft 520 with a first strandline 530a having a first end attached to the docking station 100, e.g., such as on a side of the frame 102. A winch 540a or other mechanism holds the first strandline 530a to the docking station 100. The first robot 108a attaches a second end of the first strandline 530a to the spacecraft 520. When a second robot 108b leaps to the spacecraft 520 but fall shorts, the first robot 108a fires a grappling hook from the spacecraft 520 back to the docking station 100, then both strandlines 530a-b are reeled in slowly by the winches 540a-b, as shown in FIG. 6. The robots 108a-d refuel and fill-up propellant tanks for the spacecraft 520. The robots 108a-d may also perform repairs, add robots/parts/engines/supplies or other cargo, or perform maintenance on the spacecraft 520.

As shown in FIG. 6, in an embodiment, one or more spherical vessels 106f-i or other types of storage containers, are loaded into or onto the spacecraft 520. The spherical vessels 106f-i may be attached to a top side, bottom side or all sides of the spacecraft 520. In one example, the spherical vessels 106f-i include fuel (such as methane or other fuel), supplies, engines or other cargo. The vessels 106f-i including fuel may have connecting pipes to fuel tanks of the spacecraft 520. One or more vessels 106j-k include exposed engines 610 and are positioned to provide propulsion to the spacecraft 520. For example, the spacecraft 520 includes four extra half spherical engines, two on a top side and two on a bottom side of the spacecraft 520.

The strandlines 530a-b are released and the spacecraft 520 disembarks from the mooring at the docking station 100. One or more robots may be attached externally and/or internally to the vessels 106f-i and travel with the spacecraft 520. One or more of the vessels 106f-I include thruster arms that deploy and maneuver the spacecraft 520 to separate from the docking station 100. Then, the spacecraft 520 ignites its thrusters and/or the thrusters of the vessels 106j-k to travel into space.

In an embodiment, the docking station 100 is deployed in an orbit of the moon. Spacecraft refuel and/or resupply for their particular mission while the docking station 100 remains in a geostationary orbit to the moon. Space vessels 106 travel from a surface of the moon to the docking station 100. In one example, spherical vessels 106 are launched from the surface of the moon by an electromagnetic launcher, as described in U.S. patent application Ser. No. 18/663,335, entitled, “SYSTEM AND METHOD FOR A SUPERCONDUCTIVE, ELECTROMAGNETIC LAUNCHER,” by inventor Thomas Yost, and filed on May 14, 2024, the entirety of which is incorporated by reference herein. The spherical vessels 106 include, e.g., helium-3 cargo, mined from the Moon's regolith. After the powerful launch from the Moon, the vessels 106 head to and attach to the docking station 100 or head to earth. A human astronaut monitors activity in a spherical vessel 106 equipped with living quarters on the docking station 100. The robots 108 recharge using hydrogen power generators.

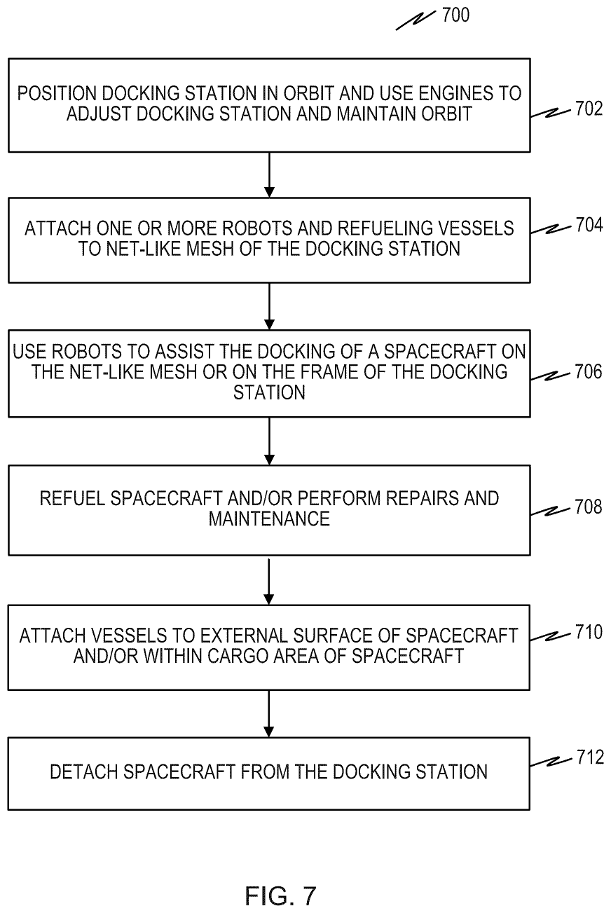

FIG. 7 is a flow diagram depicting an exemplary method 700 of the docking station 100 for refueling spacecraft according to one or more embodiments herein. At 702, the docking station 100 is positioned in a geosynchronous orbit, e.g., around the Earth, the Moon, Mars, or other celestial bodies. The docking station 100 uses engines attached to is frame 102 to adjust its position and maintain its orbit. At 704, one or more vessels 106 or other fuel storage containers are attached to the net-like mesh 104 of the docking station 100 along with one or more robots 108. The vessels 106 are attached to the net-like mesh 104 due to its magnetic properties and/or by physical hooks, wire, etc.

At 706, the robots 108 assist in the docking of a spacecraft 510, 520 on the net-like mesh or on the frame of the docking station 100. The robots 108 wirelessly communicate with the spacecraft 510, 520 and help position the spacecraft 510, 520, e.g., using strandlines, grappling hooks, or other mechanisms. At 708, the robots 108 assist in refueling the spacecraft 510, 520 and/or performing repairs and maintenance on the spacecraft 510, 520. At 710, the robots 108 assist in attaching vessels to external surfaces of spacecraft 510, 520 and/or placing the vessels within a cargo area of spacecraft 510, 520. At 712, the robots 108 help detach any strandlines or other docking mechanisms that are holding the spacecraft 510, 520 to the docking station 100. The spacecraft 712 is then free to maneuver and leave the docking station 100.

Space Station with a Plurality of Docking Stations

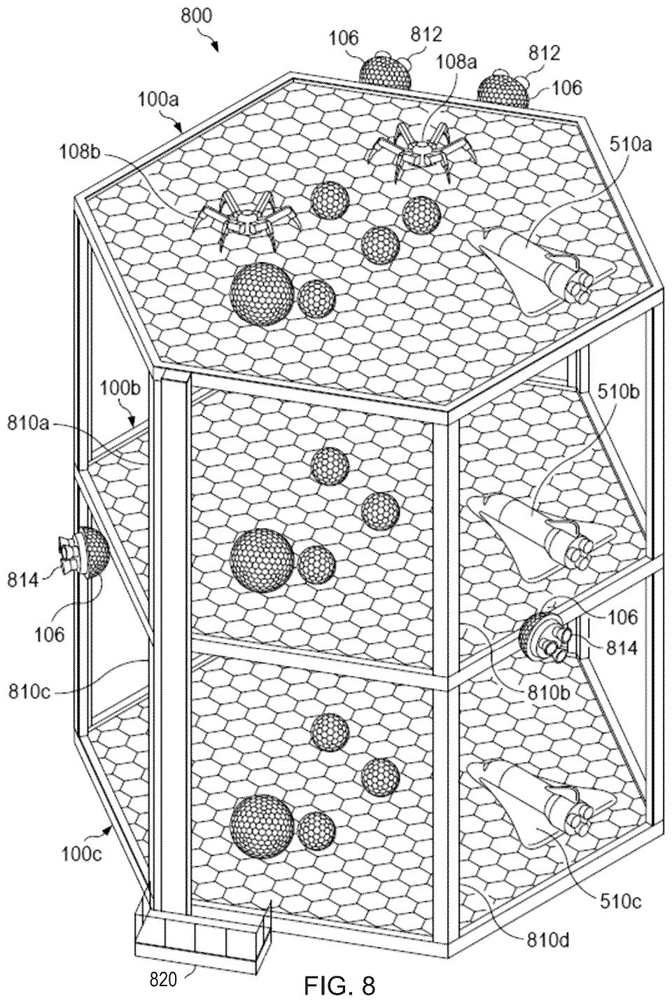

FIG. 8 illustrates an isometric view of an embodiment of a tiered docking station 800. In this embodiment, the tiered docking station 800 includes a plurality of the previously described docking stations 100a-c coupled by one or more support beams 810a-d. In this example, the plurality of docking stations 100a-c are positioned parallel to each other with the support beams 810a-d attached perpendicular to the frames 102 of the docking stations 100a-c. One or more vessels 106 are attached to the tiered docking station 800 and include main engines 812 or thrusters 814 to move the station 800 or maintain its orbit. The main engines 812 and/or thrusters 814 can be tilted for maneuvering. In an embodiment, an elevator 820 is implemented to move between tiers, e.g., to carry cargo such as one or more vessels 106, between the tiers of the docking station 800. In one example, the elevator 820 has the area and capacity to carry one or two vessels 106. The elevator 820 includes internal columns for its infrastructure and is framed outside the tiered docking station 800 as shown or alternately, inside the tiered docking station 800.

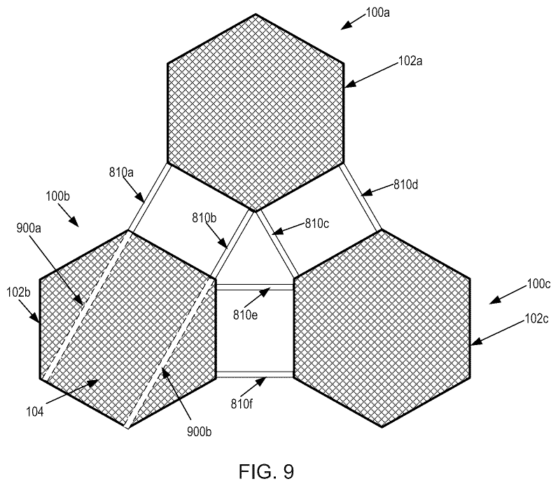

FIG. 9 illustrates an isometric view of another embodiment of a docking station 900. In this embodiment, the docking station 900 includes a plurality of the previously described docking stations 100a-c arranged in a same plane and coupled by one or more support beams 810a-f. In this example, a first side of the frame 102a of a first docking station 100a is attached to the frame 102b of a second docking station 100b. A second side of the frame 102a of the first docking station 100a is attached to a frame 102c of a third docking station 100c. The docking stations 100a-c thus lay in a same plane with the support beams 810a-f attached in a same plane as the frames 102 of the docking stations 100a-c. A plurality of the docking stations 100a-c may thus be attached in different ways to form an expanded docking station 900.

In an embodiment, one or more mesh support beams 910a-b are attached at both ends to a frame 102b of a docking station 100b and extend across the net-like mesh 104. The net-like mesh 104 is either attached to a side of the support beams 910a-b or is threaded through or around the support beams 910a-b. The support beams 910a-b provide additional support of the mesh 104 and any cargo or craft docked on the mesh 104.

### Method of Construction of a Docking Station

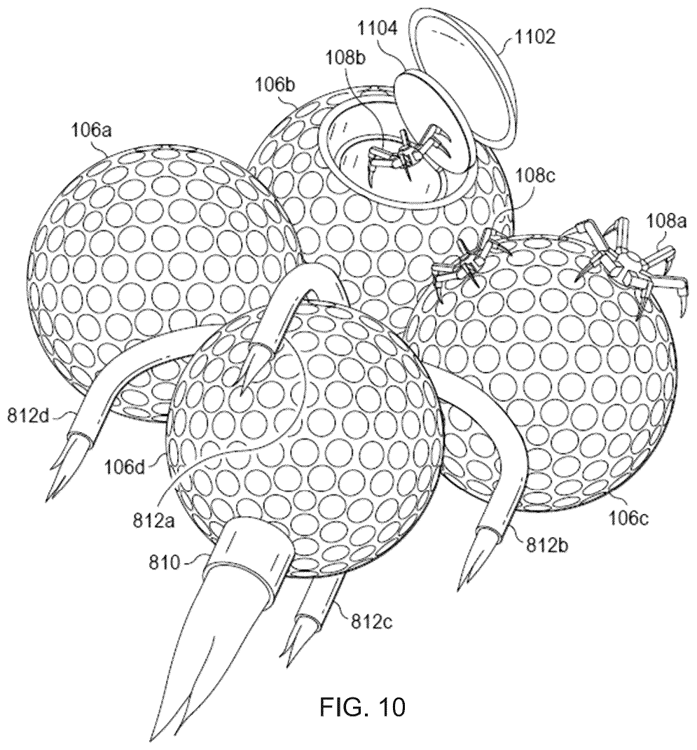

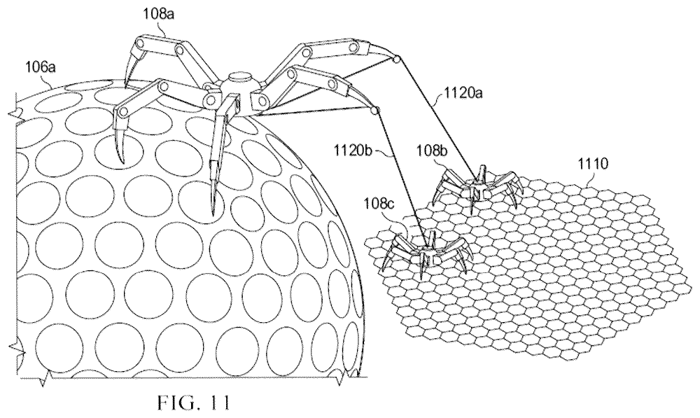

FIGS. 10-13 illustrate isometric views of construction of a docking station 100 by a plurality of vessels 106. Referring first to FIG. 10, a plurality of vessels 106a-d are launched into space, e.g., using an electromagnetic launcher, as described in U.S. patent application Ser. No. 18/663,335, entitled, “SYSTEM AND METHOD FOR A SUPERCONDUCTIVE, ELECTROMAGNETIC LAUNCHER,” by inventor Thomas Yost, and filed on May 14, 2024, the entirety of which is incorporated by reference herein. Though four vessels 106a-d are illustrated herein, additional or fewer vessels 106a-d may be used or alternate types of vessels. In this example, an engine vessel 106d includes a main engine thruster 810 and holds a large fuel payload vessels 106a-c include supplies for building the docking station 100. In other examples, the vessels 106a-c include, but are not limited to, holding any combination, of any cargo, additional propellant, oxidizer, hydrogen, electrical generator, and electrically conductive & magnetic generating devices for the outer shell to electromagnetically couple robots 108.

The vessels 106a-d each include one or more thruster arms 812a-c to stop any spin from launch and to align and link, as described in in U.S. patent application Ser. No. 18/664,170, entitled, “SYSTEM AND METHOD FOR SMART SPHERICAL CLUSTER VESSELS,” by inventor Thomas Yost, and filed on May 14, 2024, the entirety of which is incorporated by reference herein. After aligning and linking, the engine vessel 106d with the main engine thruster 810 guides the plurality of vessels 106a-d to a desired orbit and maintains the orbit during construction.

One or more of the cargo vessels 106a-c include a specialized outer shell hatch 1102 that is aligned with the outer surface and opens, e.g., using hinges and air locks. In addition, a cargo container hatch 1104 opens to expose an interior of a cargo container inside the vessel 106. One or more robots 108 exit the cargo container top hatch 1104 and then, the one or outer shell hatches 1102. As shown in FIG. 11, the robots 108a-c may have different sizes or shapes depending on their function. For example, one large robot 108a and two smaller robots 108b-c are included, e.g., with the larger robot 108a acting as a crane operator with dual strandlines 1120a-b for securing the two smaller robots 108b-c. The robots 108a-c are configured to unlock and open other hatches on the vessels 106a-c. The cargo vessels 106a-c include one or more cargo containers 1104 including magnetizable net-like rigid mesh 1110 and framing material. A methane or hydrogen generator is also stored in a cargo container below the cargo container hatch 1104 to initiate the electromagnetic grip of the mesh and electromagnetic grip of the outer shell of the vessels 106a-c.

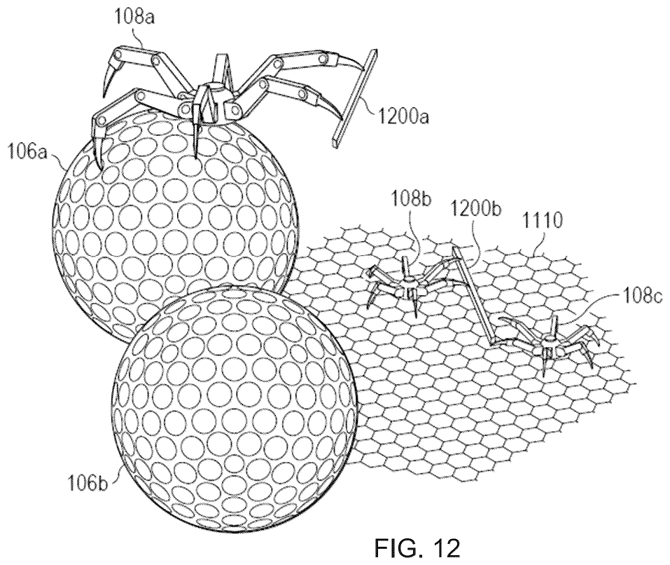

As shown in FIG. 12, the robots 108a-c remove and unravel the mesh 1110 and unload the hexagonal framework to build the frame 102. The robots 108a-c secure the framing around the mesh 1110. In one example, the larger robot 108a unloads the cargo and the two smaller robots 108b-c place and secure the framing around the mesh. In one embodiment, the plurality of vessels 106a-d and robots 108a-b complete a hexagonal frame 102 and internal mesh 104 to form a docking station 100. In this example, the frame 102 is built using a plurality of partial frames 1200a-b that are attached to the edges of the mesh 1110. The robots 108a-c return any cargo through the hatches 1102 & 1104 into the payload area of the vessels 106a-d.

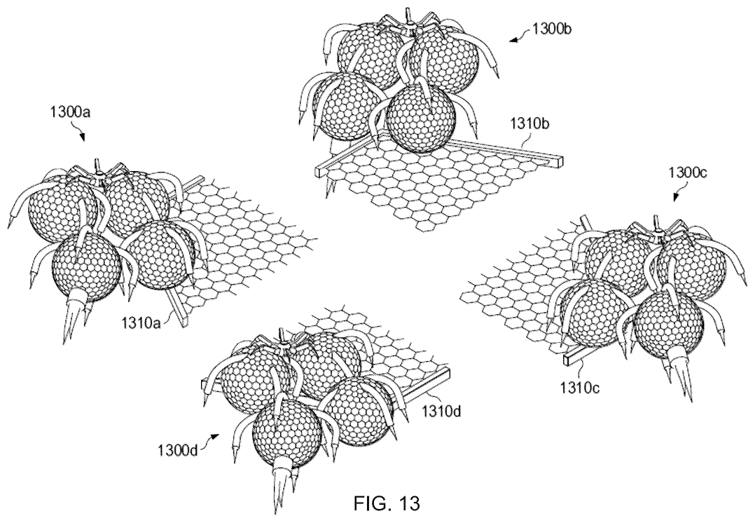

In another embodiment shown in FIG. 13, a plurality of cluster vessels 1300a-d are used to build the docking station 100. Each cluster vessel 1300a-d includes a plurality of vessels 106a-d that build at least a portion 1310a-d of the frame 102 and net-like mesh 104 of the docking station 100. The portions 1310a-d are then arranged and attached to build the docking station 100. The cluster vessels 1300a-d deploy thruster arms for better maneuverability to position the portions 1310a-d. The portions 1310a-d are attached to form the docking station 100. A generator attaches to the mesh 104 to generate an electromagnetic effect that holds the vessels 106 (or other metallic spacecraft) and/or robots 108 to the net-like mesh 104.

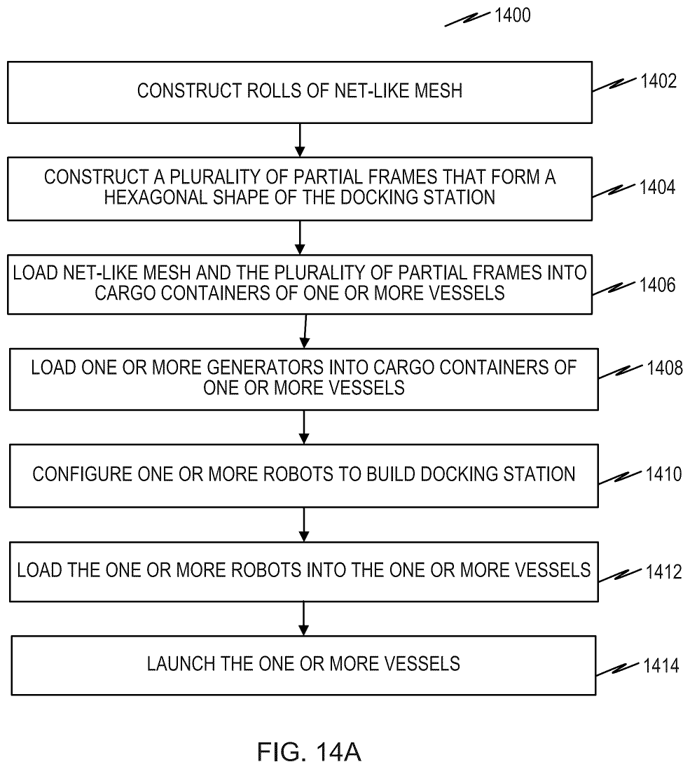

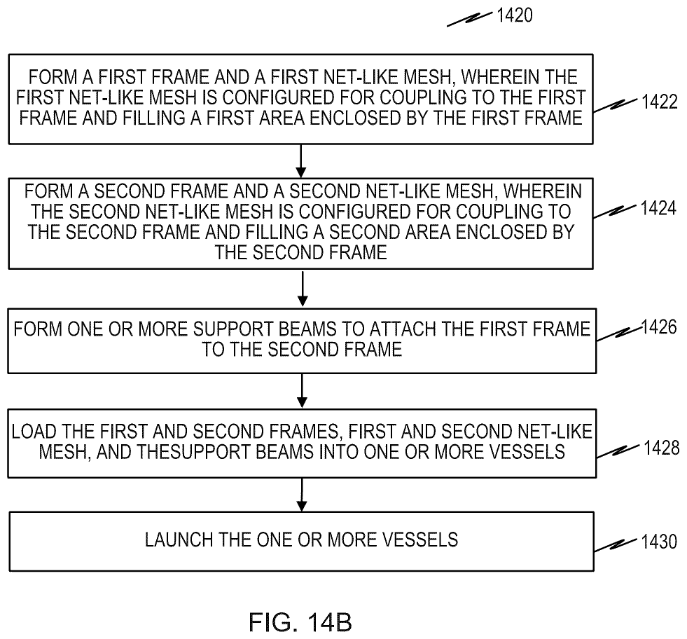

FIG. 14A is a flow diagram depicting an embodiment of a method 1400 of constructing the docking station 100 in more detail. At 1402, rolls of net-like mesh 104 are constructed from a magnetic or ferromagnetic material or other material that exhibits an ability to be strongly magnetized. The rolls of net-like mesh are formed such that when unrolled, the mesh 104 fills at least the area enclosed by the frame 102 of the docking station 100. At 1404, a plurality of partial frames 1200a-b are constructed to form the frame 102 of the docking station 100. The partial frames 1200a-b are rigid and either magnetic or non-magnetic. In one example, the partial frames 1200a-b are configured to form a hexagonal shape when attached. In another example, the partial frames 1200a-b form another shape, such as a triangle, circle, square, rectangle, octagon, etc. At 1406, the rolls of net-like mesh 104 and the partial frames 1200a-b are loaded into cargo containers 1104 of one or more vessels 106. At 1408, one or more generators, e.g., fueled by hydrogen or methane, are also loaded through the cargo hold hatch 1104 into the cargo containers inside the one or more vessels 106. The generators are configured to generate an electrical current that is applied to the net-like mesh 104 and so magnetizes the net-like mesh 104.

At 1410, one or more robots 108 are configured to assist in building the docking station 100 using the rolls of net-like mesh and the partial frames 1200a-b. The robots 108 can include the spider shaped robots shown herein or can include alternate or additional shapes. At 1412, the robots 108 are also loaded into an interior of one or more of the vessels 106. The one or more vessels 1414 are then launched towards space, e.g., using an electromagnetic launcher. Though spherical vessels 106 are described herein that are launched with an electromagnetic launcher, other types of spacecraft may be employed that are launched into alternate ways, such as a rocket based ship like the SpaceX® Starship. In one embodiment, the vessels 106 are launched for entry into a geosynchronous orbit, such as a geostationary orbit around Earth's equator.

FIG. 14B is a flow diagram depicting an embodiment of a method 1420 of constructing a tiered docking station 800 with a plurality of frames 102 in more detail. At 1422, a first frame 102 and a first net-like mesh 104 are formed or constructed, wherein the first net-like mesh 104 is configured for coupling to the first frame 102 and filing a first area enclosed by the first frame 102. In an embodiment, the first frame 102 is formed by constructing a first plurality of partial frames 1200 that when attached are configured to form a hexagonal shape. In another example, the first partial frames 1200a-b form another shape, such as a triangle, circle, square, rectangle, octagon, etc. Additionally, in an embodiment, the first net-like mesh 104 is formed and then rolled or folded.

At 1424, a second frame 102 and a second net-like mesh 104 are formed or constructed, wherein the second net-like mesh 104 is configured for coupling to the second frame 102 and filing a second area enclosed by the second frame 102. Similarly to the first frame, in an embodiment, the second frame 102 is formed by constructing a second plurality of partial frames 1200 that when attached are configured to form a hexagonal or another shape. Additionally, in an embodiment, the second net-like mesh 104 is formed and then rolled or folded.

At 1426, one or more support beams 810 are formed or constructed and configured to couple the first frame 104 to the second frame 104 to form a tiered docking station 800. Each of the support beams 810 may be formed in parts that attached into a support beam 810. At 1428, the first and second frames 102, the first and second net like meshes 104, and the support beams 810 are loaded into cargo containers of one or more vessels 106. At 1430, the one or more vessels 106 are then launched for entry into space.

### Double Meshed Lander

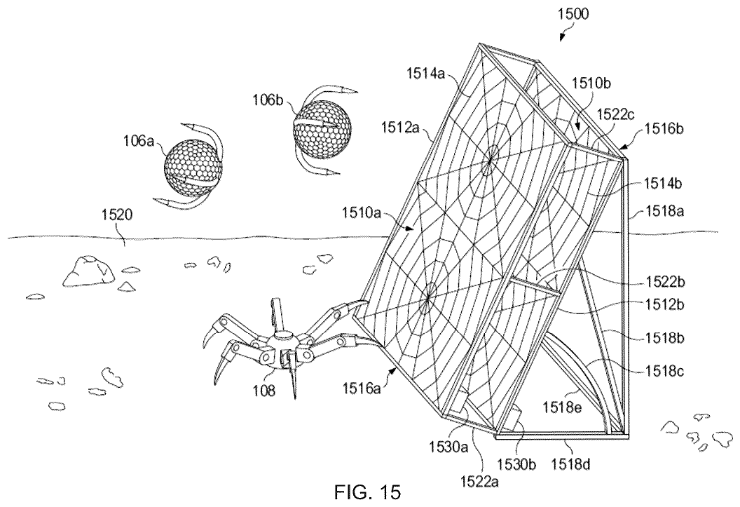

FIG. 15 illustrates an isometric view of an embodiment of a double meshed cargo lander 1500 according to one or more embodiments herein. The lander is configured to slow and stop a spacecraft, such as the vessel 106, when landing on a celestial body. The lander 1500 includes a first webbed structure 1510a and a second webbed structure 1510b, with the first and second structures 1510a-b in parallel. Each of the structures 1510a-b includes a frame 1512a-b that surrounds and supports webbing 1514a-b within the frame 1512a-b. The lander 1500 is positioned on a surface 1520 of a celestial body, in this example the Moon, but may be deployed on the Earth, Mars, a docking station 100, etc. For descent to the surface 1520 of the moon, the frames 1512a-b are tilted at an approximately 65 degree angle, e.g., within a range of 60 degrees to 70 degrees with the surface 1520. The angle may be adjusted outside this range depending on the angle of descent of the vessels 106a-b towards the surface 1520.

One or more support beams 1518a-e are attached to the second frame 1512b and moored to the surface 1520. In one example, the one or more support beams 1518a-b are straight and positioned at a linear angle to the surface 1520. In another example, another type of support beam 1518c is arched and moored to second frame 1512b and the surface 1520 or to another support beam 1518d on the surface. In addition, the first frame 1512a is attached to and supported by the second frame 1512b by one or more support beams 1522a-c. In another embodiment, the first frame 1512a is supported by one or more support beams moored to the surface, similar to support beams 1518a-e.

The webbing 1514a-b inside the frames 1512a-b includes fibers or wires, such as steel drag line cables, which are interwoven with one or more pressurized decelerators 1530a-b, wherein an amount of tension on the fibers is regulated to slow and stop the vessels 106a-b during landing. For example, a strandline of the webbing 1514 is attached through a first input of the decelerator 1530 and out a second output of the decelerator 1530 and attached to a mount on the surface 1520 of the planet. The pressurized decelerator 1530 monitors a tension of the fibers and maintains the tension below a predetermined tension. The predetermined tension is less than the tension at which the fibers would break or would dent the vessels 106a-b. For example, the pressurized decelerator 1530 increases a length of the fibers to maintain the tension below the predetermined tension when impacted by a vessel 106a-b. Upon impact, the fibers elongate and slow and stop the vessels 106a-b, and the vessels 106a-b are then electromagnetically coupled to webbing 1514a-b. One or more robots 108 then remove the vessel 106a-b from the webbing 1514a-b.

As a vessel 106a-b approaches the surface 1520 of the Moon, one or more arm thrusters 812a-c of the vessel 106a-b are deployed to fire in a direction of the lander 1500 and/or surface 1520 to decelerate the vessel 106a-b. Before touchdown/impact, the one or more arm thrusters 812a-c are retracted. The vessel 106a-b sinks into the two webbings 1514a-b and the pressurized decelerator lessens the force of the impact. After impact, the vessel 106a-b is electromagnetically coupled to webbing 1514a-b. A robot 108 then unloads the payload of the vessel 106a-b.

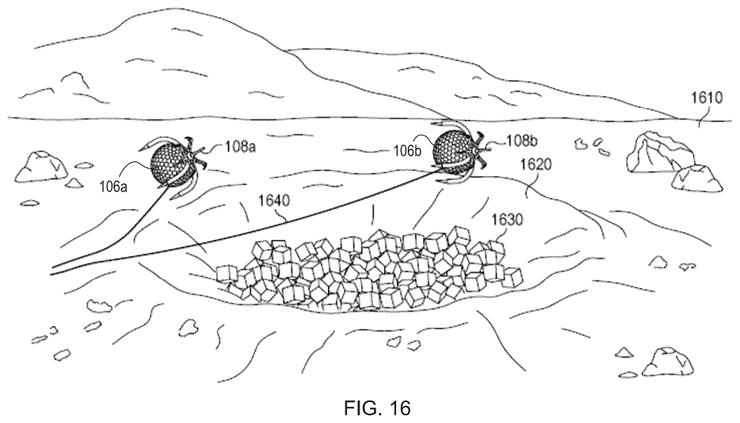

FIG. 16 illustrates an isometric view of another embodiment of the double meshed cargo lander 1500 according to one or more embodiments herein. In this embodiment, the lander 1500 is positioned parallel to the surface 1620 of a celestial body that has an atmosphere, such as Earth or Mars. One or more parallel layers of webbing 1514 are positioned to extend wholly or at least partially over an existing crater or an excavated pit or other hole. In one example, the hole 1620 is filled with an elastic material 1630 or a plurality of pieces of elastic material 1630. In another example, the hole 1620 is filled with an inflatable mattress, foam pits or cushion.

One or more robots 108a-b are configured to construct the webbing 1514 using dragline cables 1640 or other fibers. The cables 1640 are anchored to the surface 1610 or attached to a frame 1512 that is then anchored to the surface 1610. The robots 108 may include propulsion systems to fly across the hole 1620 to construct the webbing 1514. The robots 108 build a first webbing 1514a and a second webbing 1514b above and parallel to the first webbing 1514a. Both webbings 1514a-b are positioned parallel to the surface 1610 and wholly or at least partially over the hole 1620. One or more pressurized decelerators 1530 are attached to the webbings 1514a-b to monitor and adjust tension of the cables 1640.

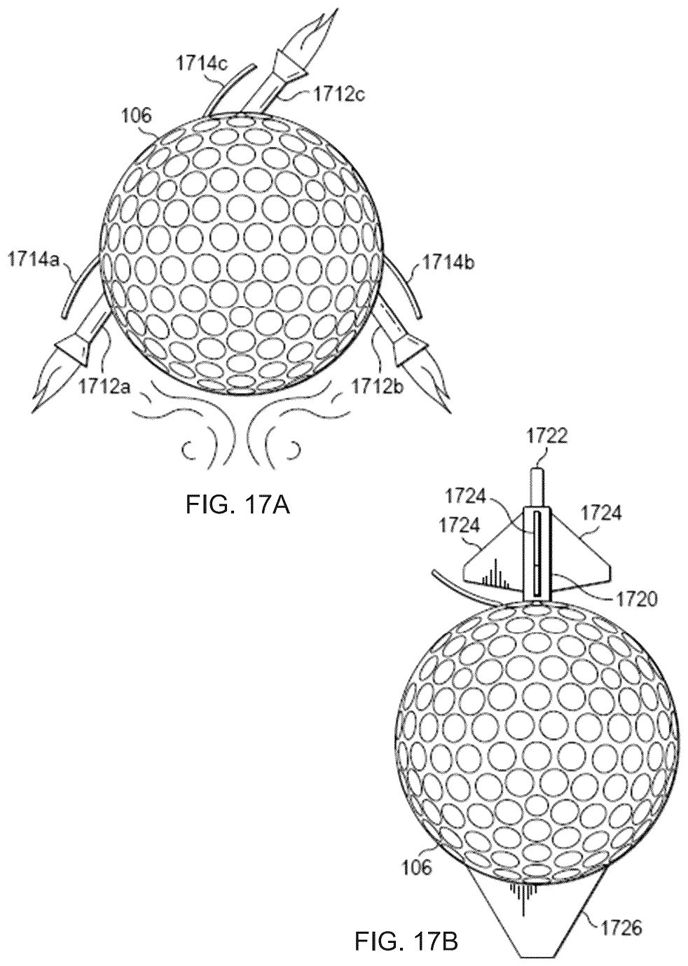

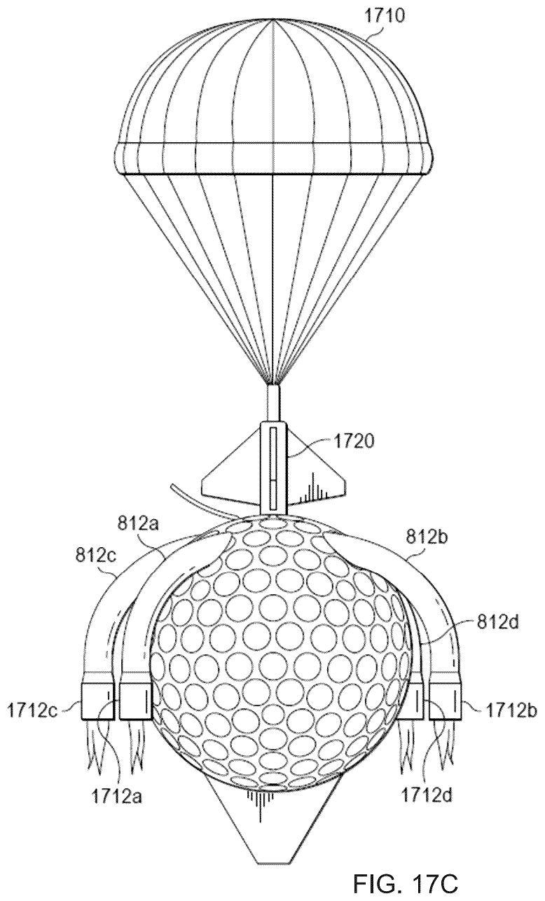

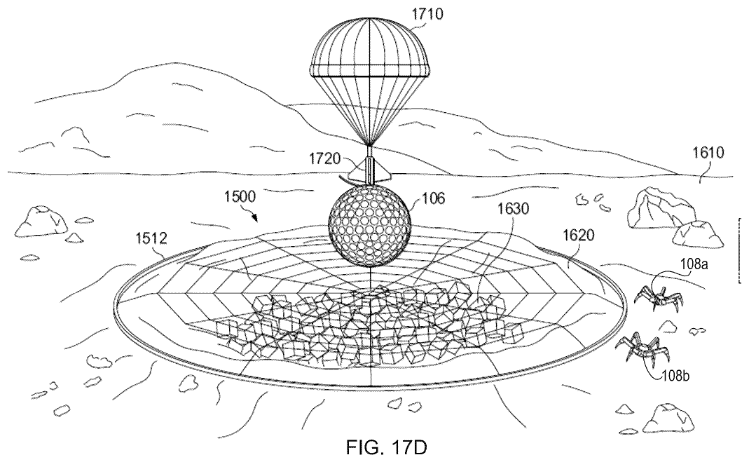

In an embodiment, a vessel 106 employs a parachute 1710 to slow its descent through the atmosphere, as shown in FIGS. 17A-D. In one example, as shown in FIG. 17A, after entering the atmosphere, with all the thrusters closed but as the vessels spins, then the vessel 106 deploys nozzles 1712a-b (e.g., at the ends of the thruster arms 812) from under hatch covers 1714a-c. The nozzles 1712a-b initiate thrust around the vessel 106 to slow and stop a spin of the vessel 106. After the vessels stops spinning, the thrusters are closed and as shown in FIG. 17B, the vessel 106 then deploys a stanchion 1720 with from a top hatch of the vessel 106 such that the stanchion 1720 extends vertically from a top of the vessel 106. The stanchion 1720 includes a rigid, upright post 1722 forming a support for the parachute 1710. The stanchion 1720 also includes one or more fins 1724 extending perpendicular from the post 1722. The vessel 106 may also deploy a navigational fin 1726 from a bottom hatch such that the navigational fin 1726 extends downward from the vessel 106. In one example, the fins 1724, 1726 are grid fins having an interior lattice of smaller aerodynamic surfaces arranged within a box. The grid fins 1724, 1726 can be folded, pitched forward or backwards.

Referring to FIG. 17C, at approximately 6 miles altitude, the vessel 106 releases the parachute 1710 from the top of the stanchion 1720. At 1 mile to touchdown, the vessel engages a plurality of thruster arms 812a-d with nozzles 1712a-d. The thruster arms 812a-d are adjusted to point the nozzles 1712a-d to steer and align the vessel 106 with the lander 1500. In an embodiment, the vessel 106 ejects a robot 108 with a parachute to land separately. The robot 108 may include thrusters to steer and slow descent. For example, a spider-shaped robot 108 may include thrusters or jet packs at the ends of its legs to provide thrust. Two or more other legs include, e.g., nitrogen shock absorbers to brace for landing. The shock absorbers are then jettisoned after landing for increased maneuverability. As shown in FIG. 17D, the vessel 106 approaches the lander 1500, disengages the nozzles 1712a-d, and retracts the plurality of thruster arms 812a-d. The vessel 106 lands on the webbing 1512 which flexes to slow and stop the vessel 106.

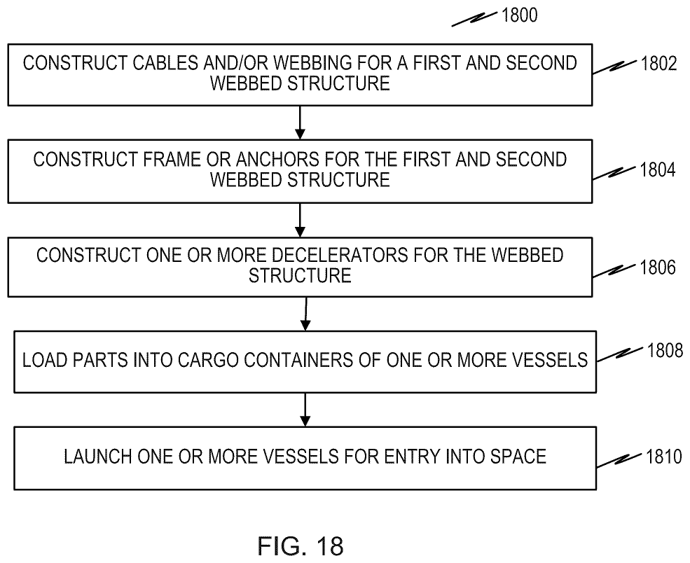

FIG. 18 is a flow diagram depicting an embodiment of a method 1800 of constructing parts of a lander 1500 prior to launching into space. At 1802, cables 1640 and/or webbing 1514 of the lander 1500 for first and second webbed structures 1510 are formed or constructed of electrically conductive and/or magnetic material. The cables 1640 and/or webbing 1514 are rolled or wound. The frames 1512 or anchors for the first and second webbed structures 1510 are formed at 1804. At 1806, a decelerator 1530 is constructed for attachment to the webbed structures 1510. These and other parts are then loaded into cargo containers of one or more vessels 106 at 1808. At 1810, the one or more vessels 106 are then launched for entry into space.

As may be used herein, the term “operable to” or “configurable to” indicates that an element includes one or more of components, dimensions, circuits, instructions, modules, data, input(s), output(s), etc., to perform one or more of the described or necessary corresponding functions and may further include inferred coupling to one or more other items to perform the described or necessary corresponding functions. As may also be used herein, the term(s) “coupled,” “coupled to,” “connected to” and/or “connecting” or “interconnecting” includes direct connection or link between components or between nodes/devices and/or indirect connection between components or nodes/devices via an intervening item. As may further be used herein, inferred connections (i.e., where one element is connected to another element by inference) includes direct and indirect connection between two items in the same manner as “connected to.” As may be used herein, the terms “substantially” and “approximately” provides an industry-accepted tolerance for its corresponding term and/or relativity between items.

Note that the aspects of the present disclosure may be described herein as a process that is depicted as a schematic, a flow chart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

The various features of the disclosure described herein can be implemented in different systems and devices without departing from the disclosure. It should be noted that the foregoing aspects of the disclosure are merely examples and are not to be construed as limiting the disclosure. The description of the aspects of the present disclosure is intended to be illustrative, and not to limit the scope of the claims. As such, the present teachings can be readily applied to other types of apparatuses and many alternatives, modifications, and variations will be apparent to those skilled in the art.

In the foregoing specification, certain representative aspects have been described with reference to specific examples. Various modifications and changes may be made, however, without departing from the scope of the present invention as set forth in the claims. The specifications and figures are illustrative, rather than restrictive, and modifications are intended to be included within the scope of the claims. Accordingly, the scope of the claims should be determined by the descriptions herein and their legal equivalents rather than by merely the examples described. For example, the components and/or elements recited in any apparatus claims may be assembled or otherwise operationally configured in a variety of permutations and are accordingly not limited to the specific configuration recited in the claims.

Furthermore, certain benefits, other advantages and solutions to problems have been described above with regard to particular embodiments; however, any benefit, advantage, solution to a problem, or any element that may cause any particular benefit, advantage, or solution to occur or to become more pronounced are not to be construed as critical, required, or essential features or components of any or all the claims.

As used herein, the terms “comprise,” “comprises,” “comprising,” “having,” “including,” “includes” or any variation thereof, are intended to reference a nonexclusive inclusion, such that a process, method, article, composition or apparatus that comprises a list of elements does not include only those elements recited, but may also include other elements not expressly listed or inherent to such process, method, article, composition, or apparatus. Other combinations and/or modifications of the above-described structures, arrangements, applications, proportions, elements, materials, or components used in the practice of the present invention, in addition to those not specifically recited, may be varied or otherwise particularly adapted to specific environments, manufacturing specifications, design parameters, or other operating requirements without departing from the general principles of the same.

Moreover, reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is intended to be construed under the provisions of 35 U.S.C. § 112 (f) as a “means-plus-function” type element, unless the element is expressly recited using the phrase “means for” or, in the case of a method claim, the element is recited using the phrase “step for.”

1. A tiered spacecraft docking station, comprising:
a first frame enclosing a first area and a first net-like mesh coupled to the first frame and filling the first area enclosed by the first frame;
a second frame enclosing a second area and a second net-like mesh coupled to the second frame and filling the second area enclosed by the second frame; and
a plurality of support beams that attach the first frame to the second frame.

2. The tiered spacecraft docking station of claim 1, wherein the first frame is parallel to the second frame.

3. The tiered spacecraft docking station of claim 1, wherein the first frame and the second frame are in a same plane.

4. The tiered spacecraft docking station of claim 1, wherein the first net-like mesh and the second net-like mesh are electrically conductive and/or magnetic and are configured to create an electromagnetic coupling effect.

5. The tiered spacecraft docking station of claim 1, wherein the first frame and the second frame each form a same shape, wherein the same shape is at least one of: a hexagon, circle, square, rectangle, octagon, or triangle.

6. The tiered spacecraft docking station of claim 1, wherein the first net-like mesh comprises a first plurality of wires interconnected to form a pattern filling the first area enclosed by the first frame; and
the second net-like mesh comprises a second plurality of wires interconnected to form the pattern filling the second area enclosed by the first frame.

7. The tiered spacecraft docking station of claim 5, wherein the pattern is selected from one of a hexagon, square, triangle, rectangle, or oblong shape.

8. A method for constructing a tiered spacecraft docking station, comprising:
obtaining a first frame and a first net-like mesh, wherein the first net-like mesh is configured for coupling to the first frame and filling the first area enclosed by the first frame;
obtaining a second frame and a second net-like mesh, wherein the second net-like mesh is configured for coupling to the second frame and filling the second area enclosed by the first frame;
obtaining a plurality of support beams that are configured for attaching the first frame to the second frame;
loading the first frame, the second frame, and the plurality of support beams into one or more cargo containers of one or more vessels; and
launching the one or more vessels for entry into space.

9. The method of claim 8, further comprising:
obtaining one or more generators, wherein the one or more generators are configured to generate an electric current through the first net-like mesh and/or the second net-like mesh; and
loading the one or more generators into the one or more cargo containers of the one or more vessels.

10. The method of claim 8, further comprising:
launching the one or more vessels for entry into a geosynchronous orbit around Earth.

11. A lander, comprising:
a first webbed structure including first webbing;
a second webbed structure including second webbing, wherein the second webbed structure is in parallel with the first webbed structure;
a decelerator coupled to the first webbed structure and/or the second webbed structure.

12. The lander of claim 11, wherein the first webbing and the second webbing are electrically conductive and/or magnetic and are configured to create an electromagnetic coupling effect.

13. The lander of claim 11, wherein the decelerator maintains a tension in the first webbing and the second webbing below a predetermined threshold tension.

14. The lander of claim 11, wherein the first webbing and the second webbing are positioned at an angle to a surface of a celestial body.

15. The lander of claim 14, wherein the angle of the first webbing and the second webbing to the surface of the celestial body is in a range of 60 degrees to 70 degrees.

16. The lander of claim 11, wherein the first webbing and the second webbing are positioned parallel to a surface of a celestial body.

17. The lander of claim 16, wherein the first webbing and the second webbing are positioned wholly or at least partially over a hole in the surface of the celestial body.

18. A method for constructing a lander, comprising:
obtaining a first webbed structure and a second webbed structure;
obtaining one or more decelerators for attachment to the first webbed structure and/or the second webbed structure;
loading the first webbed structure, the second webbed structure, and the one or more decelerators into one or more cargo containers of one or more vessels; and
launching the one or more vessels for entry into space.

19. The method of claim 18, wherein first webbed structure and the second webbed structure include webbing of electrically conductive and/or magnetic cables.

20. The method of claim 18, further comprising:
obtaining one or more generators, wherein the one or more generators are configured to generate an electric current through the first webbed structure and/or the second webbed structure; and
loading the one or more generators into the one or more cargo containers of the one or more vessels.
